(19) United States
(12) Patent Application Publication
(10) Pub. No.: US 2011/0242010 A1
(43) Pub. Date: Oct. 6, 2011

(54) MOBILE COMMUNICATION TERMINAL DEVICE

(75) Inventors: Ting-Lin Chang, Taoyuan (TW); Ching-Feng Hsieh, Taipei (TW)

(73) Assignee: ASKEY COMPUTER CORPORATION, Taipei (TW)

(21) Appl. No.: 12/815,197

(22) Filed: Jun. 14, 2010

(30) Foreign Application Priority Data
Mar. 31, 2010 (TW) 099109817

(51) Int. Cl. G06F 3/041; G08B 21/00

(52) U.S. Cl. 345/173; 340/665

(57) ABSTRACT

A mobile communication terminal device includes a display unit, a sensing unit, a carrier disposed on the display unit and covering the sensing unit, a data processing unit connected with both the sensing unit and the display unit, and a handheld housing for accommodating the aforementioned units therein while exposing the carrier therefrom, wherein the carrier is adapted to carry and convey an external force to the sensing unit such that the data processing unit is enabled to receive and then calculate the magnitude of the external force sensed by the sensing unit and thereby provide an external force sensing function to the device.

### BACKGROUND OF THE INVENTION

1. Field of the Invention

The present invention relates generally to mobile communication terminal devices, and more particularly, to a mobile communication terminal device with a weighing function.

2. Description of Related Art

In logistics operations, the identification code of an item to be transported is read through a smart handheld computer such that logistics personnel can obtain related information of the item, such as the item number, name, delivery address and amount, based on the identification code of the item. Further, a weighing scale or the like is required to measure the weight of the item so as to calculate the delivery fee for the item based on the weight of the item. However, it will be a big burden for the logistics personnel to take with them multiple kinds of devices or tools. The devices or tools also increase the cost.

Further, weighing demands may occur in offices if something needs to be mailed. In addition, weighing demands may occur during meals since some persons practice healthy eating. However, when these persons eat out, it is very inconvenient for them to take with them a weighing tool, thus causing difficulties in controlling calorie intake. Therefore, how to provide a product with a weighing function so as to meet people's demands for weighing in work and life has become urgent.

### SUMMARY OF THE INVENTION

In view of the above drawbacks of the prior art, the present invention provides a mobile communication terminal device with a weighing function.

In order to achieve the above and other objects, the present invention provides a mobile communication terminal device, which comprises: a display unit, a sensing unit; a carrier disposed on the display unit and covering the sensing unit for carrying and conveying an external force to the sensing unit; a data processing unit connected to the sensing unit and the display unit for receiving and calculating the magnitude of the external force sensed by the sensing unit; and a handheld housing for accommodating and securing the display unit, the sensing unit, the carrier and the data processing unit while exposing the carrier therefrom.

In an embodiment, the carrier can be a transparent substrate or a touch panel.

Therefore, the present invention not only eliminates the need of additional measuring tools but also increases the functionality and convenience of the mobile communication terminal device.

### BRIEF DESCRIPTION OF DRAWINGS

FIG. 1A is a perspective view of a mobile communication terminal device according to a first embodiment of the present invention;

FIG. 1B is a basic structural block diagram of the mobile communication terminal device of FIG. 1A;

FIG. 1C is a partial structural cross-sectional view of the mobile communication terminal device of FIG. 1A;

FIG. 2 is a partial structural cross-sectional view of a mobile communication terminal device according to a second embodiment of the present invention;

FIG. 3 is a partial structural cross-sectional view of a mobile communication terminal device according to a third embodiment of the present invention;

FIG. 4 is a partial structural cross-sectional view of a mobile communication terminal device according to a fourth embodiment of the present invention; and

FIG. 5 is a partial structural cross-sectional view showing weighing of an object by the mobile communication terminal device of FIG. 1C.

### DETAILED DESCRIPTION OF PREFERRED EMBODIMENTS

The following embodiments are provided to illustrate the disclosure of the present invention, these and other advantages and effects can be apparent to those in the art after reading this specification. The present invention can be implemented or applied by other different embodiments, and details in the specification can be modified and varied without departing from the spirit of the present invention based on different viewpoints and applications.

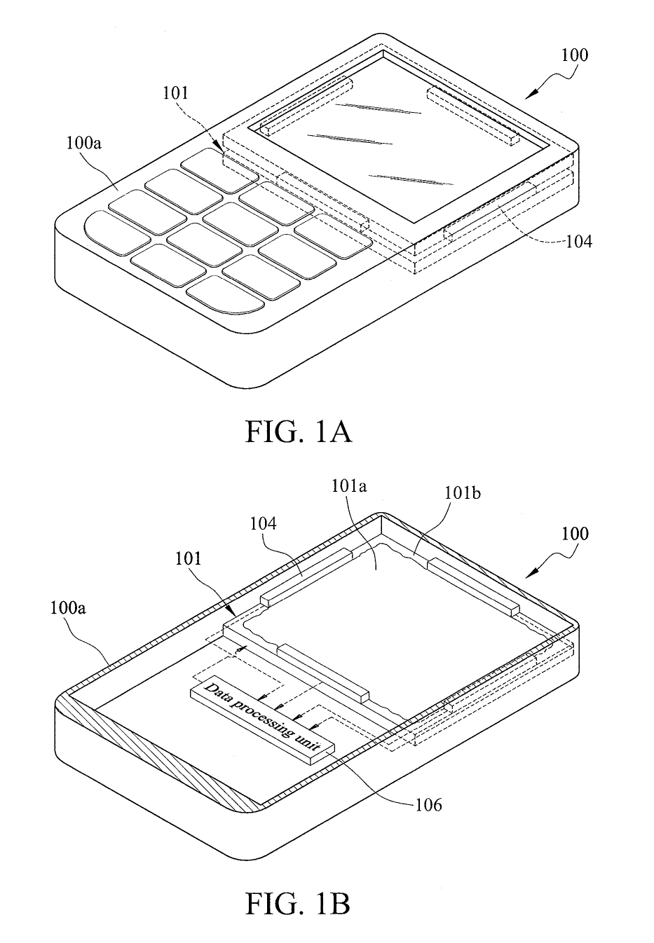

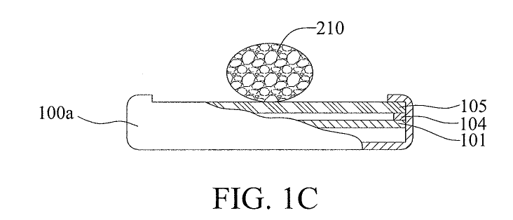

FIG. 1A is a perspective view of a mobile communication terminal device according to a first embodiment of the present invention. FIG. 1B is a basic structural block diagram of the mobile communication terminal device of FIG. 1A. FIG. 1C is a partial structural cross-sectional view of the mobile communication terminal device of FIG. 1A. Referring to FIGS. 1A to 1C, the mobile communication terminal device 100 with a function of sensing an external force comprises: a display unit 101, a sensing unit 104, a carrier 105, a data processing unit 106 and a handheld housing 100a. The mobile communication terminal device 100 may be, but not limited to, a mobile phone, a smart phone, a smart type handheld computer, a satellite positioning device, or a personal digital assistant. It should be noted that for expository purpose, only major elements related to the present invention are shown in the drawings. Other detailed elements such as connecting ports, microphones or speakers are not shown in the drawings.

The handheld housing 100a accommodates and secures the display unit 101, the sensing unit 104, the carrier 105 and the data processing unit 106 while exposing the carrier 105 therefrom.

The display unit 101 can be such as an LCD (liquid crystal display), an LED (light emitting diode) display or the like. In the present embodiment, the display unit 101 comprises a display panel 101a and a frame 101b disposed around the periphery of the display panel 101a.

The sensing unit 104 is used to sense the external force. In the present embodiment, the sensing unit 104 comprises a plurality of pressure sensors spacingly disposed adjacent to the periphery of the display unit 101, wherein each of the pressure sensors may be made of a piezoelectric material, a piezoelectric actuator or a load cell. It should be noted that the number, shape or disposing method of the pressure sensors of the sensing units 104 are not limited to the present embodiment. In another embodiment, the sensing unit 104 can be a ring-shaped pressure sensor disposed on the frame 101b of the display unit 101. The frame 101b of the display unit 101 can be made of a rigid material, for example, a metal frame or a plastic frame, so as for the sensing unit 104 to be disposed thereon. In another embodiment, the display unit 101 only comprises the display panel 101a. That is, there is no frame 101b disposed around the periphery of the display panel 101a. In such a case, the sensing unit 104 is disposed adjacent to the periphery of the display unit 101 (the periphery of the viewable area of the display panel 101a).

The carrier 105 is disposed on the display unit 101 and covers the sensing unit 104. The carrier 105 is used for carrying and conveying the external force to the sensing unit 104. The external force may, for example, come from an object 210 to be weighed. The carrier 105 of the present embodiment can be a transparent substrate, such as a glass substrate, an acrylic substrate or a plastic substrate. In the present embodiment, the carrier 105 can not only weigh the object 210 but also protect the display unit 101. According to the design requirement of the display panel, the area of the carrier 105 can be greater than or equal to the display area (viewable area) of the display panel 101a. Therefore, the carrier 105 disposed on the display unit 101 and covering the sensing unit 104 carries the external force, for example, the object 210 to be weighed, while the design of the display area of the mobile communication terminal device 100 is not changed.

In addition, the carrier 105 can be made of a rigid material so as to fully convey the external force applied by the object 210 to the sensing unit 104. The sensing unit 104 further senses the external force applied on the carrier 105 so as to generate a pressure signal, wherein the pressure signal can be such as a voltage signal or a current signal. In practice, the requirement of the rigidity of the carrier 105 depends on the pressure sensing scope of the sensing unit 104. For example, if the weighing scope of the sensing unit 104 falls in the tolerable stress condition of the carrier 105, the rigidity of the material does not need to be considered, otherwise, if the weighing scope of the sensing unit 104 falls beyond the tolerable stress condition of the carrier 105, the thickness and material rigidity should be considered. In other words, design requirements are varied according to the weighing scope and size of the display panel.

The data processing unit 106 is connected to the sensing unit 104 and the display unit 101 so as to receive the external force sensed by the sensing unit 104, thereby calculating the weight of the object 210 according to the external force. It should be noted that the resource of the external force is not limited to the object weight. In another embodiment, the external force may be an impact force of a baseball hitting the carrier 105. In other words, the external force can be any force coming from the outside of the mobile communication terminal device.

In an embodiment, the data processing unit 106 comprises an ADC (analog-to-digital converter) and a processor. In particular, the ADC converts the pressure signal from the sensing unit 104 to a digital signal, the processor calculates the weight of the object 210 according to the digital signal and the disposing position of the sensing unit 104, and further the display unit 101 controlled by the processor displays the calculated weight for users. In another embodiment, the data processing unit 106 can be a microprocessor with an analog-to-digital converting function, which converts the pressure signal from the sensing unit 104 to a digital signal, calculates the weight of the object 210 according to the digital signal and the disposing position of the sensing unit 104, and further enables the display unit 101 to display the weight of the object 210 for users.

Further, the calculated result can be audio outputted. In particular, the mobile communication terminal device 100 further comprises an audio device (not shown) for voice broadcasting the calculated weight, wherein the data processing unit 106 generates an audio signal corresponding to the calculated weight of the object so as to enable the audio device to broadcast voice according to the audio signal.

The mobile communication terminal device of the present invention further comprises a switching unit (not shown) for turning on or turning off the weighing function. The switching unit can be a button disposed on the mobile communication terminal device 100 or an application program installed in the mobile communication terminal device 100. Users can press the button or choose to execute the application program so as to turn on or turn off the weighing function.

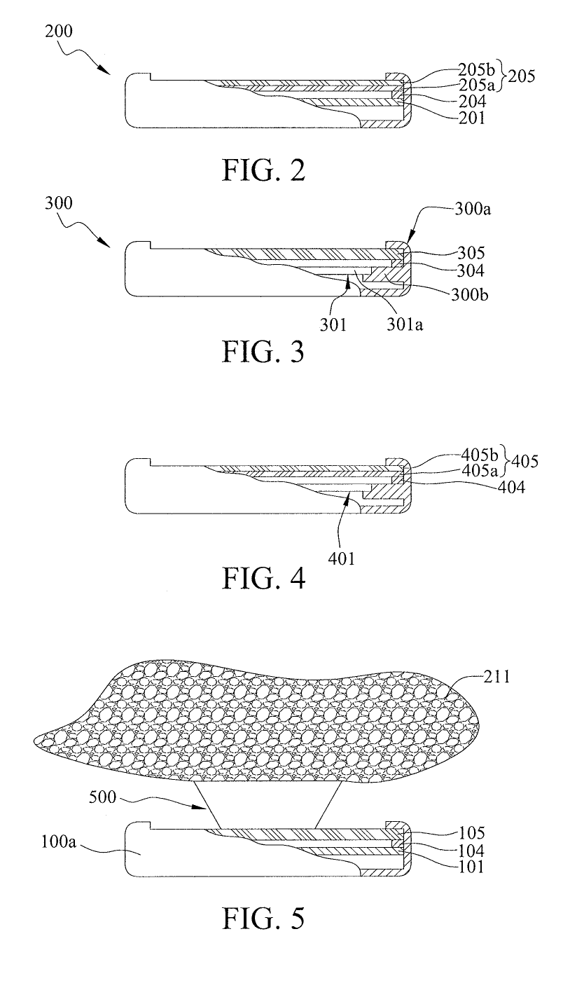

FIG. 2 is a partial structural cross-sectional view of a mobile communication terminal device according to a second embodiment of the present invention. The difference of the present embodiment from the first embodiment of FIG. 1C is the carrier 205 of the present embodiment is a touch panel instead of the transparent substrate. The carrier 205 of the mobile communication terminal device 200 of the present embodiment is disposed on the display unit 201 and covers the sensing unit 204. The carrier 205 is such as a capacitor touch panel, a resistor touch panel or a multi-touch panel.

The carrier 205 of the present embodiment comprises an enhanced substrate 205a and a touch substrate 205b, wherein the enhanced substrate 205a is made of a transparent material with high rigidity and disposed between the sensing unit 204 and the touch substrate 205b.

FIG. 3 is a partial structural cross-sectional view of a mobile communication terminal device according to a third embodiment of the present invention. The Difference of the present embodiment from the first embodiment of FIG. 1C is the pressure sensors of the mobile communication terminal device 300 of the present embodiment are spacingly disposed adjacent to a support portion 300b on the periphery of the display unit 301. The support portion 300b is a positioning frame or a positioning rib inside the handheld housing 300a for laterally positioning the display unit 301. Since the pressure sensors of the sensing unit 304 are disposed on the support portion 300b instead of on the display panel 301a of the display unit 301, the external force can be prevented from being transmitted to the display panel 301a of the display unit 301, thereby effectively preventing damage of the display panel 301a that otherwise may occur due to the external force applied on the display panel 301a.

FIG. 4 is a partial structural cross-sectional view of a mobile communication terminal device according to a fourth embodiment of the present invention. The difference of the present embodiment from the third embodiment of FIG. 3 is the carrier 405 of the present embodiment is a touch panel instead of the transparent substrate. The carrier 405 of the mobile communication terminal device of the present embodiment is disposed on the display unit 401 and covers the sensing unit 404. The carrier 405 of the present embodiment comprises an enhanced substrate 405a and a touch substrate 405b, wherein the enhanced substrate 405b is made of a transparent material with high rigidity and disposed between the sensing unit 404 and the touch substrate 405b.

FIG. 5 shows a partial structural cross-sectional view showing weighing of the object by the mobile communication terminal device of FIG. 1C. In the present embodiment, a height element 500 can be selectively disposed on the carrier 105. The height element 500 has a height greater than the height difference between the carrier 105 and the surface of the handheld housing 100a so as to carry an object 211 that has a cross-sectional area greater than the carrying area of the carrier 105 or an object without a fixed shape, thus preventing the object 211 from contacting the area outside the carrier 105 that may otherwise adversely affect the accuracy of the measuring result.

It should be noted that the shape of the height element 500 is not limited to FIG. 5. The height element 500 can be such as a cylinder body, a tube body, a plate body or a cap. The height element 500 can be applied to the mobile communication terminal devices of FIG. 1C to FIG. 4. In addition, the height element 500 should be weighed first and its weight should be detracted from the measured weight, which can alternatively be implemented through built-in software. Therefore, the application of the height element 500 allows more kinds or dimensions of objects to be weighed while the original weighing function is not affected.

Therefore, the present invention integrates a weighing function into a mobile communication terminal device, which increases the functionality of the mobile communication terminal device and facilitates users to readily achieve the purpose of weighing. As such, the functionality and application of the mobile communication terminal device are enhanced.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A mobile communication terminal device with a function of sensing an external force, comprising:
a display unit;
a sensing unit for sensing the external force;
a carrier disposed on the display unit and covering the sensing unit for carrying and conveying the external force to the sensing unit;
a data processing unit connected to the sensing unit and the display unit for receiving and calculating a magnitude of the external force sensed by the sensing unit; and
a handheld housing for accommodating and securing the display unit, the sensing unit, the carrier and the data processing unit while exposing the carrier therefrom.

2. The device of claim 1, wherein the sensing unit comprises a plurality of pressure sensors spacingly disposed adjacent to a periphery of the display unit.

3. The device of claim 1, wherein the display unit comprises a display panel and a frame disposed around a periphery of the display panel, the sensing unit being disposed on the frame.

4. The device of claim 1, wherein the sensing unit comprises a plurality of pressure sensors.

5. The device of claim 1, wherein the sensing unit comprises a ring-shaped pressure sensor.

6. The device of claim 1, wherein the sensing unit comprises a plurality of pressure sensors spacingly disposed adjacent to a support portion on a periphery of the display unit.

7. The device of claim 6, wherein the support portion is a positioning frame inside the handheld housing for laterally positioning the display unit.

8. The device of claim 1, wherein the data processing unit comprises an analog-to-digital converter and a processor, the analog-to-digital converter converting a pressure signal related to the external force sensed by the sensing unit into a digital signal and the processor calculating the magnitude of the external force according to the digital signal.

9. The device of claim 1, wherein the data processing unit is a microprocessor with an analog-to-digital converting function.

10. The device of claim 1, wherein the carrier is a transparent substrate or a touch panel.

11. The device of claim 1, wherein the external force comes from an object to be weighed.

12. The device of claim 1, further comprising a height element disposed on the carrier and having a height greater than a height difference between the carrier and a surface of the handheld housing.

13. The device of claim 12, wherein the height element is a cylinder body, a tube body, a plate body or a cap.

14. The device of claim 1, wherein the display unit displays the magnitude of the external force calculated by the data processing unit.

15. The device of claim 1, further comprising an audio device for voice broadcasting the magnitude of the external force, wherein the data processing unit generates an audio signal corresponding to the magnitude of the external force so as to enable the audio device to broadcast voice according to the audio signal.
